(19) United States
(12) Patent Application Publication
(10) Pub. No.: US 2018/0113995 A1
(43) Pub. Date: Apr. 26, 2018

(54) Pharmaceutical Dispensing Method in an Unattended Medical Kiosk

(71) Applicants: David R. Hall, Provo, UT (US); Dan Allen, Springville, UT (US); Cameron Price, Provo, UT (US)

(72) Inventors: David R. Hall, Provo, UT (US); Dan Allen, Springville, UT (US); Cameron Price, Provo, UT (US)

(21) Appl. No.: 15/333,834

(22) Filed: Oct. 25, 2016

(51) Int. Cl. G06F 19/00; G06F 21/32

(52) U.S. Cl. CPC G06F 19/3462; G06F 21/32; G06F 19/322

(57) ABSTRACT

A pharmaceutical dispensing method using an unattended medical kiosk is disclosed. The pharmaceutical dispensing method securely dispenses medication to users, and provides a format for dispensing that can be easily localized, such as in the form of an unattended medical kiosk while maintaining security, privacy, and verified user identification. In some embodiments the pharmaceutical dispensing method relies on medical testing in the kiosk in order to verify user identification before dispensing medication. In an embodiment a user payment bypass may be utilized in cases of high medical risk allowing the user to get life-saving medication quickly, and in another embodiment a method of remote prescription approval is provided. Further varieties and embodiments of pharmaceutical dispensing using an unattended medical kiosk are disclosed.

### BACKGROUND

### Field of the Invention

The present invention relates to the dispensing of pharmaceuticals in an unattended medical kiosk.

### Background of the Invention

The process of acquiring medication in today's society can often be cumbersome, inefficient, and expensive. For controlled substances and other medications, an individual will likely have to meet with a doctor in person one or more times, and following these appointments a doctor may choose to issue a prescription. One of the reasons an individual is required to meet with a doctor in person is to authenticate an identity of the individual. This is usually accomplished by the individual providing a photo identification card at the time of the in-person appointment with the doctor. Photo identification is also required when picking up a prescription from a brick and mortar pharmacy to positively identify and authenticate an individual. Person to person contact is required for traditional medical appointments and traditional pharmaceutical dispensing causing unnecessary expense and inconvenience for patients and providers.

What is needed is a way to innovatively address user identification and authentication in an unmanned medical kiosk. A proper solution would take into account the importance of doctor involvement in issuing and dispensing prescriptions to positively identify and authenticated users of an unmanned medical kiosk.

### SUMMARY

This invention has been developed in response to the present state of the art and, in particular, in response to the problems and needs in the art that have not yet been fully solved by currently available systems and methods. Accordingly, a pharmaceutical dispensing method has been developed. Features and advantages of different embodiments of the invention will become more fully apparent from the following description and appended claims, or may be learned by practice of the invention as set forth hereinafter.

The pharmaceutical dispensing method presented provides a method of securely dispensing medication to users, and provides of format for dispensing that can be easily localized, such as in the form of an unattended medical kiosk or booth. This localization is necessary to minimize the expenditure of user resources. It diminishes costs associated with appointments at medical facilities as well as costs associated with pharmacy visits. The kiosk may provide after-hours emergency care for life-threatening medical conditions in addition to dispensing and refilling medications for routine medical care. The kiosk may be attached to a pharmacy, hospital, doctor's office, Wal-Mart, etc.

To receive medication, a user must first provide proof of their identification, which could be in the form of a password, identification card, or biometric data. Biometric data may be presented in the form of a fingerprint scan, bioimpedance scan, retinal scan, facial scan, height measurement, weight measurement, or a combination thereof. If users successfully provide proof of their identity, they may be granted access to medical diagnostic equipment with which they can perform certain tests on themselves. User healthcare records may be obtained from a pharmaceutical or health database based on an identity of the user. Instructions teaching the user how to use the medical diagnostic equipment to perform diagnostic testing may be given to the user to enable the user to perform self-testing. The self-testing may produce diagnostic testing results from the medical diagnostic equipment being used by the user. The diagnostic medical test results may be compared with the user's online healthcare records to confirm identification of the user and identify conditions that may need medical attention. The results of these tests may also be shared with medical professionals such that they may review the results and issue a prescription remotely and in real-time or near real-time such as by responding to an email or text message generated by the unattended medical kiosk or by a remote server in communication with the unattended medical kiosk.

When the pharmaceutical dispensing method is presented in the form of an unattended kiosk or booth, it may further comprise a privacy barrier, a chair, a scale, and a user interface. The user interface may also include a user payment interface, such that a user may receive, pay for, and fill their prescription all in a single location. User payment may also be used as a further identity verification. Medical diagnostic equipment is securely stored in the kiosk or booth and access controlled, and when a user is granted access to equipment the equipment remains securely tethered to the interior of the secure storage. Furthermore, the medical diagnostic equipment may include location sensors such that they may be easily located if the equipment is stolen.

The user interface may have variable functionality such that it may be updated for changing laws or improved security. Furthermore, exceptions may be programmed into the pharmaceutical dispensing method such that if the results of diagnostic tests indicate that a user is at immediate risk of death or serious impairment payment may not be required for medication that will relieve the risk. In the same scenario a requirement for a remotely approved prescription may also be nullified so that life-saving medication may be immediately dispensed.

The method of pharmaceutical dispensing may provide a receptacle that comprises a sorter, scanner, and incinerator such that excess medicine may be disposed of, and it may either be scanned, sorted and subsequently collected or it may be incinerated on site. This allows for convenient, local disposal of excess medicine by individuals.

A user of a medical kiosk may obtain daily medications from the kiosk on the way to work or while on a lunch break. The medications may be dispensed and paid for on a daily basis.

Consistent with the foregoing, a pharmaceutical dispensing method is disclosed. In an embodiment the pharmaceutical dispensing method is presented functioning in a booth. In another embodiment the pharmaceutical dispensing method is presented functioning in a kiosk. In various embodiments the privacy barrier is a door or a curtain. In an embodiment a chair is provided for user convenience, while in another embodiment no chair is provided. In an embodiment of the method a user payment bypass is evident for cases of high medical risk, and in another embodiment a method of remote prescription approval is provided. Further varieties and embodiments of a pharmaceutical dispensing method are disclosed.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows an overview of the pharmaceutical dispensing method;

FIG. 2 shows the steps for disposal of excess medication according to the pharmaceutical dispensing method;

FIG. 3 charts the flow of events after performing a diagnostic test, outlining the identification and payment bypass in the event of results that indicate immediate risk;

FIG. 4 shows an exterior view of a medical kiosk using the pharmaceutical dispensing method with a door as a privacy barrier;

FIG. 5 shows an embodiment of a user interface panel;

FIG. 6 is an isometric view of the interior of a kiosk for pharmaceutical dispensing;

FIG. 7 is a top down view of a potential layout for a pharmaceutical dispensing kiosk;

FIG. 8 is a front view of storage for the diagnostic equipment;

FIG. 9 is an embodiment of the medical kiosk with a curtain serving as a privacy barrier; and

FIG. 10 is a method of remote prescription approval.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

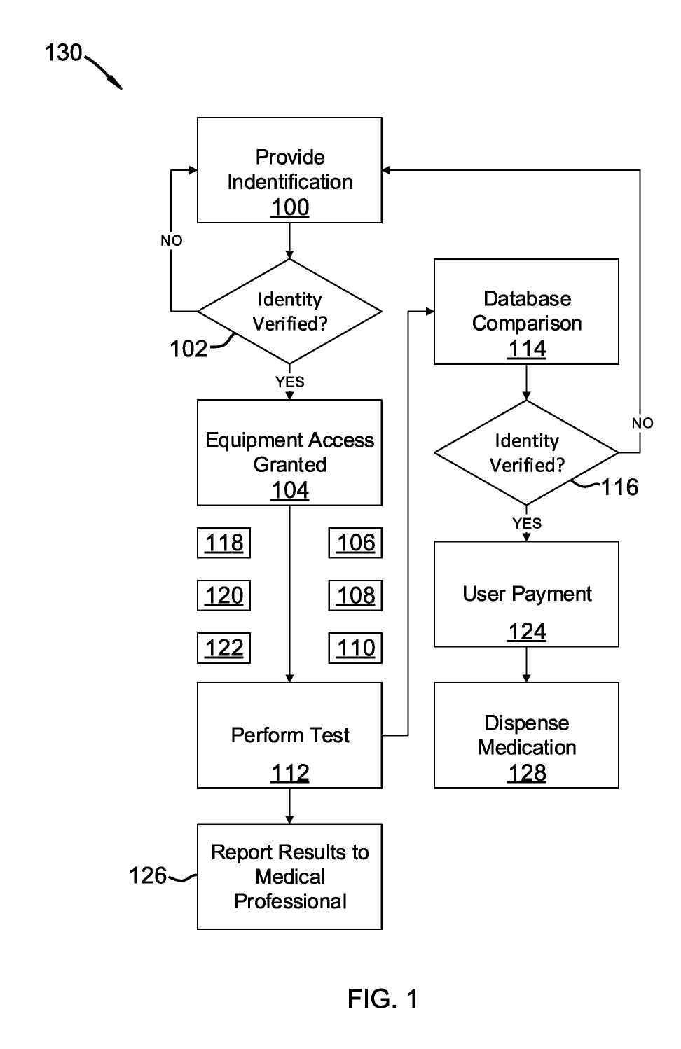

Referring to FIG. 1, a pharmaceutical dispensing method is initiated by a user when he or she provides identification 100 to a system 130 operating according to the pharmaceutical dispensing method. Following providing identification 100, the system 130 performs a verification 102 of the given identity. The verification 102 may be accomplished by any combination of a fingerprint sensor, bioimpedance sensor, retinal scan, facial scan, scale, identification card, password, or other form of individual identification. If the verification 102 is unsuccessful, the user is notified to again provide identification 100. If the verification 102 is successful the user is granted access 104 to diagnostic equipment 106, 108, 110, 118, 120, 122 and user health database records are obtained from a local or remote healthcare database. User healthcare records may be obtained from a pharmaceutical or health database based on an identity of the user. Instructions teaching the user how to use the medical diagnostic equipment to perform diagnostic testing may be given to the user to enable the user to perform self-testing. The self-testing may produce diagnostic testing results from the medical diagnostic equipment being used by the user. There may be more or less diagnostic equipment than what is listed, and the user may be given limited access only to those items that are needed by the user. The diagnostic equipment 106, 108, 110, 118, 120, 122 may include but is not limited to: a stethoscope, a sphygmomanometer, an electrocardiograph, a thermometer, a pulse oximeter, x-ray machine, a video enabled otoscope, a video enabled ophthalmoscope, a tongue depressor, a blood glucose monitoring device, or a vital signs monitor. Following granting access 104, the user may perform diagnostic tests with any of the diagnostic equipment 106, 108, 110, 118, 120, 122 that he or she has received access to, and may receive direction for proper testing by visual or auditory means. For instance, a user may arrive at the kiosk with a sore throat and want to be checked for strep. After the user is identified, the user may be granted access to testing equipment for testing for strep throat, weighing the user, measuring a height of the user, performing a facial or retinal scan of the user, and/or any other medical test with the ability to identify or confirm the identity of the user. Video and audio instructions may be given within the kiosk instructing the user how to self-administer a strep test. If the user is confirmed positive for strep and the identity of the user is confirmed by one or more medical tests, medication used for the treatment of strep throat may be dispensed to the user based on a confirmed identity of the user and the strep test of the user. Vital signs of the user may be used as an additional form of user verification and identification. Vital signs may include: blood pressure, weight, height, bioimpedance, heart rate, pulse transit time, temperature, etc. User vital signs may be stored and trended as a function of time each time a user uses a kiosk. Confirming user identity using two or more medical tests may also be implemented to insure treatment of the correct individual.

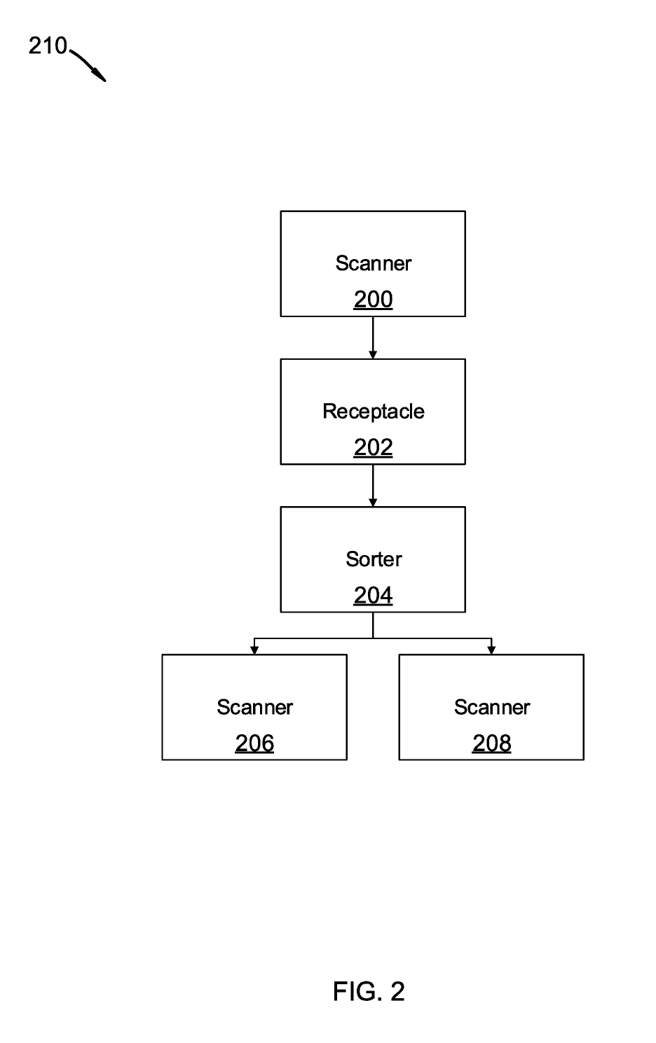

FIG. 2 shows a method of receiving medication 210 wherein a scanner 200 scans a pill bottle or container for indication of pills contained within. Subsequently a user may pour the pills into a receptacle 202 which receives the pills and guides them to a sorter 204. The sorter 204 may sort pills based on data from the scanner 200, data from a chemical test, or measurements of size, color, or mass. Sorted pills are either incinerated in an incinerator 206 or they are stored for eventual removal 208, depending on pill constituents and applicable regulations.

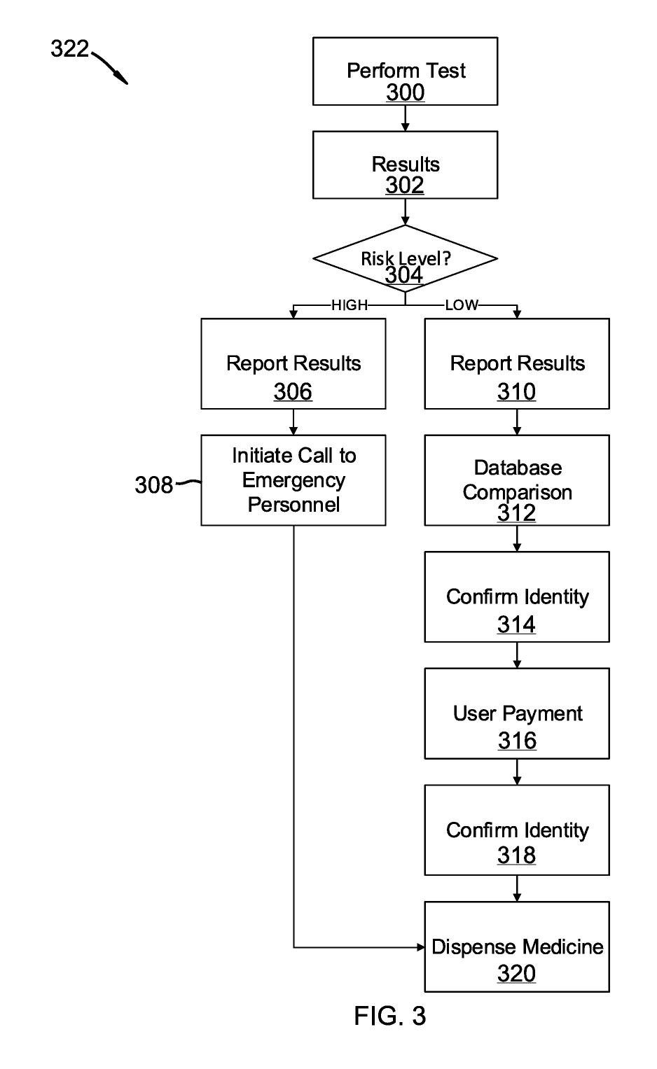

FIG. 3 shows a method of exception 322 wherein a user performs a diagnostic test 300 and results 302 from the diagnostic test 300 are used to determine a level of risk 304 for a user. If the results 302 indicate the user is at high risk this may mean that the user is in immediate danger of death or serious and permanent impairment. If the results 302 indicate the user is at low risk this may mean that the user does not exhibit any criteria for high risk. If the results 302 indicate that the user is at low risk, the method of exception to user payment 320 will report 310 the results 302 to a database for recording purposes. The method of exception to user payment 320 will then perform a comparison 312 with the database using the current data for a user against previous data for the same user. This will be used for an identity confirmation 314 before prompting the user to provide payment 316. The means of payment 316 provided by a user may be used to for further identity confirmation 318. If identity confirmation 314 or identity confirmation 318 is unsuccessful, the method of exception to user payment may be terminated. If identity confirmation 312 and identity confirmation 316 are successful, then dispensing of medicine 320 is initiated. In order for the method of exception to user payment to indicate a high risk, the results that indicate high risk need to be corroborated by at least two different diagnostic tests. If the results 302 indicate the user is at high risk, the method of exception 322 will report 306 the results 302 to a database for recording purposes and initiate a call to emergency personnel 308 on behalf of the user. The user may terminate the call to emergency personnel 308 if desired. The method of exception to user payment 320 may then initiate the dispensing of medicine 318 if medication for a high risk condition of the user is available. The method of exception 322 may also allow for a user to receive medication by a medical professional responding to a text message. For example, if a user is identified and medical testing indicates that the user is having a heart attack, the user may be given a drug such as nitroglycerin by a medical professional responding to a text message indicating that a life threating emergency exists. The text message may provide a link to a database record with all necessary information of the person in the unattended kiosk. The text message may provide a direct call link between the medical professional and the person in the unattended kiosk when the medical professional clicks a direct connect call link within the text message or within a database instance of the data referenced by a texted link to the medical professional's smart phone or tablet. A heart attack may be identified by more than one medical test at the kiosk. Other such conditions may include a severe allergic reaction, various heart conditions, lack of sufficient oxygen levels in the blood, low blood sugar, high blood sugar, low body temperature, high body temperature, etc.

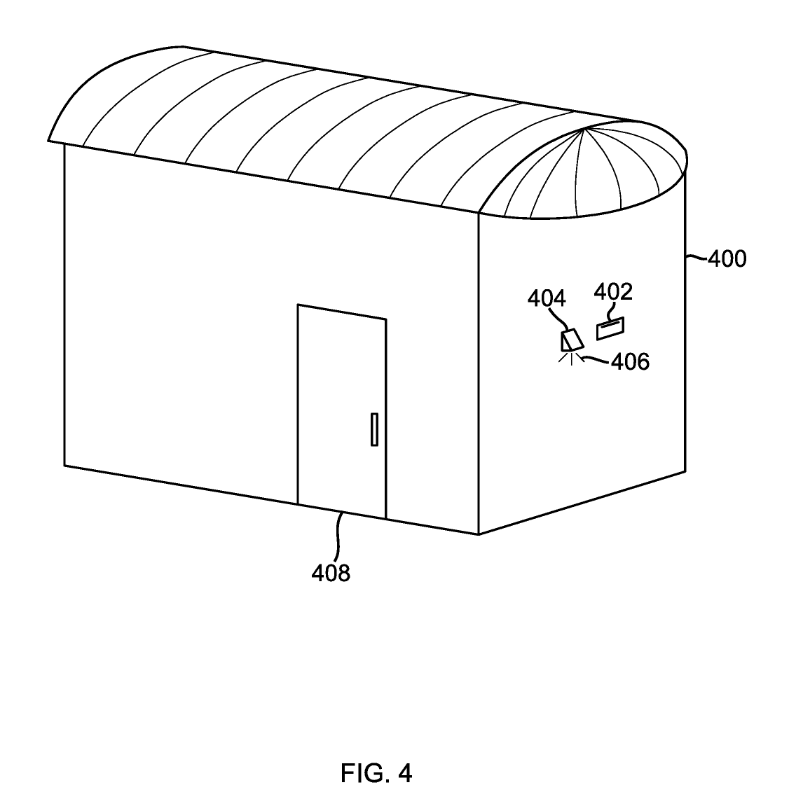

FIG. 4 shows a kiosk 400 that may be comprised in a pharmaceutical dispensing method. The kiosk 400 comprises a privacy barrier 408, a scanner 406, scanner housing 404, and a receptacle 403. The privacy barrier 408 may be a hinged door, a sliding door, a curtain, or other barrier that may block a user from view. The privacy barrier 408 may comprise a latch, a doorknob, a handle, a keypad, a push bar, or motorized components to enable hands-free operation of the privacy barrier 408. The receptacle 402 may further comprise a sorter or incinerator, the sorter further comprising a scale, chemical testing system, optical analysis system, or some other component useful for analysis of received pills. The pills may be sorted according to pill dimensions, color, texture, or constituents.

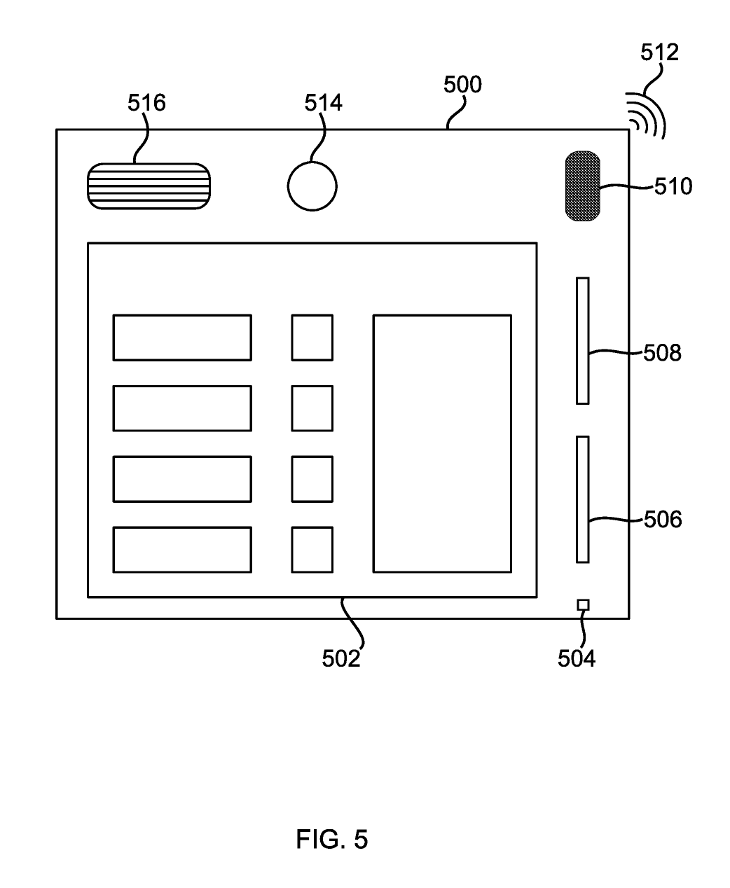

FIG. 5 shows a user interface 500 with a screen 502. The screen 502 may be touch enabled. The user interface 500 further comprises a microphone 504, card scanners 506 and 508, a fingerprint sensor 510, a camera 514, and a speaker 516. The user interface 500 comprises wireless capabilities 512. The user interface 500 may be used to perform an initial identification of a user using methods that may include a retinal scan with the camera 514, a fingerprint scan with the fingerprint sensor 510, a voice recognition test using the microphone 504, a password entered on the screen 502, or an identification card inserted into one of the card scanners 506 or 508. The identification card used with the card scanners 506 or 508 may be a government issued identification card or some other card produced and issued specifically for use with the pharmaceutical dispensing method. The user interface 500 may also be used to communicate with medical professionals, view active prescriptions, request prescriptions, or receive instructions on operation of medical diagnostic equipment. The user interface 500 may comprise variable functionality such that it may be updated or edited to accommodate for varying local laws or security needs.

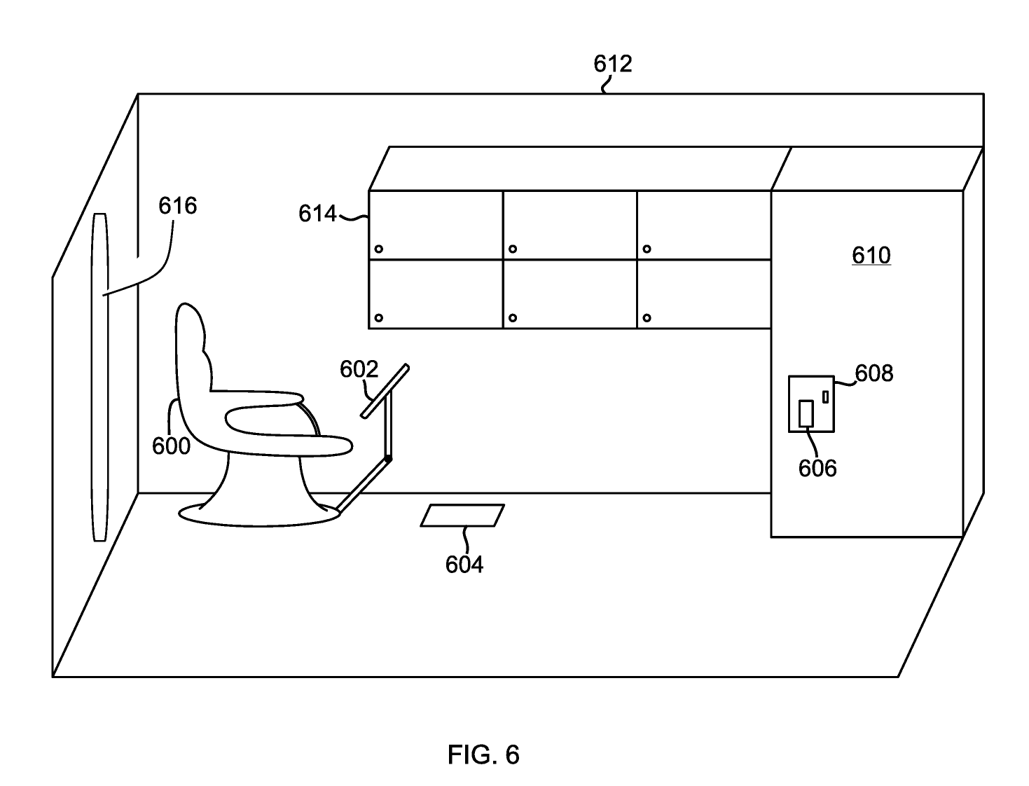

FIG. 6 shows an interior view of a kiosk 612. The kiosk 612 comprises a chair 600, a user interface 602, a scale 604, a pharmaceutical dispenser 610, and storage compartments 614. Medical diagnostic equipment may be stored in the storage compartments 614, and access to them may be limited according to a user's needs. Access to the storage compartments 614 may be controlled by means of automated locking mechanisms that are controlled by the user interface 602. The storage compartments 614 may have handles or grips to assist a user to open them, or they may open by motorized means such that they may be opened without physical contact from the user. The scale 604 may be used as part of a user identification process as well as a medical diagnostic tool. The pharmaceutical dispenser 610 comprises a dispensing compartment 608 where dispensed medicine 606 is collected by the user at completion of a pharmaceutical dispensing method. The kiosk 612 may include a height measurement device 616. Height device 616 comprises optical sensors which detect a height of a user when a user stands in front. Optical transmitters and receiver may be located within device 616 such that reflected light may be detected and a user's height determined, as is known in the art. A user's height may serve as a form of identification and verification of a user's identity.

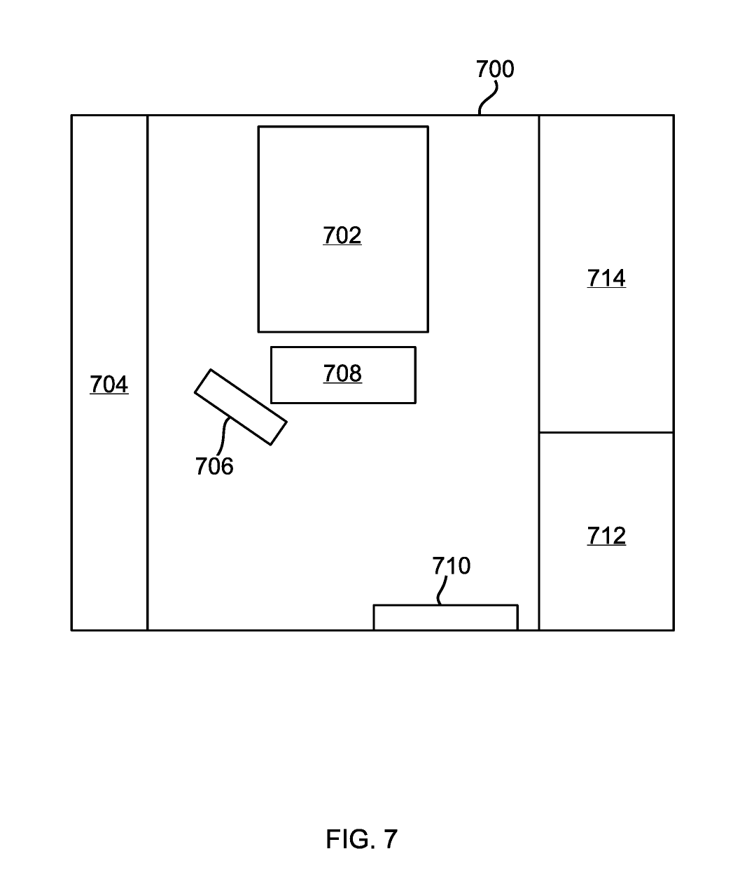

FIG. 7 shows a top down view of a layout of a kiosk 700. A user may enter the kiosk 700 through a privacy barrier 710. The kiosk 700 further comprises a chair 702, a scale 708, a user interface 706, storage compartments 704, a pharmaceutical dispenser 714, and a receptacle 712.

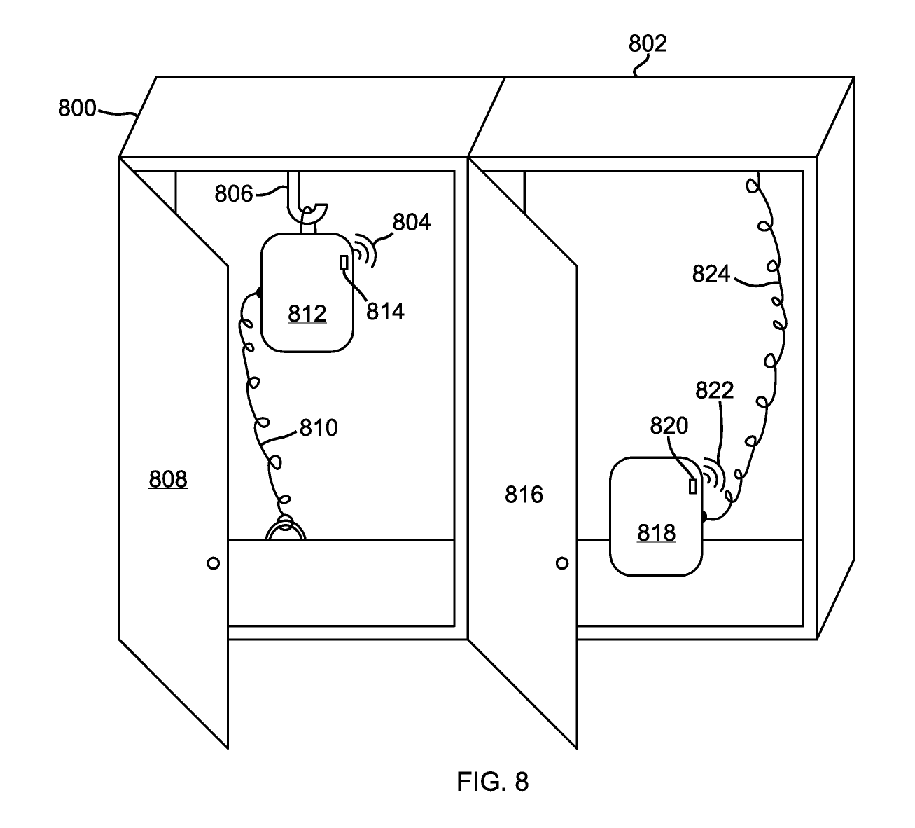

FIG. 8 shows storage compartments 800 and 802 with compartment doors 808 and 816 in an open position. Within the storage compartments 800 and 802 are diagnostic equipment 812 and 818, respectively. Diagnostic equipment 812 is tethered to the storage compartment 800 by means of a tether 810 and diagnostic equipment 818 is tethered to the storage compartment 802 by means of a tether 824. Diagnostic equipment 812 and 818 comprise location sensors 814 and 820, respectively. Location sensors 814 and 820 comprise wireless capabilities 804 and 822, respectively, such that the diagnostic equipment 812 or 818 may be remotely located in the event of loss or theft. Diagnostic equipment 812 as shown is mounted by means of a mount 806. Mount 806 may comprise a hook, a rope, a magnet, a clip, or some other means of attachment. The diagnostic equipment 812 and 818 may comprise, but are not limited to, any of the following: a stethoscope, a sphygmomanometer, an electrocardiograph, a scale, a height measurement device, a thermometer, a device for measuring arms, legs or parts of an arm or leg, a palm print scanner, a footprint scanner, a pulse oximeter, a video enable otoscope, pulse oximeters, a video enable ophthalmoscope, a tongue depressor, a blood glucose monitoring device, or a vital signs monitors. The compartment doors 808 and 816 are controlled by a user interface, and when in the closed position they may not be manually operable. The compartment doors 808 and 816 serve the purpose of securely limiting access to diagnostic equipment 812 and 818 to only authorized users.

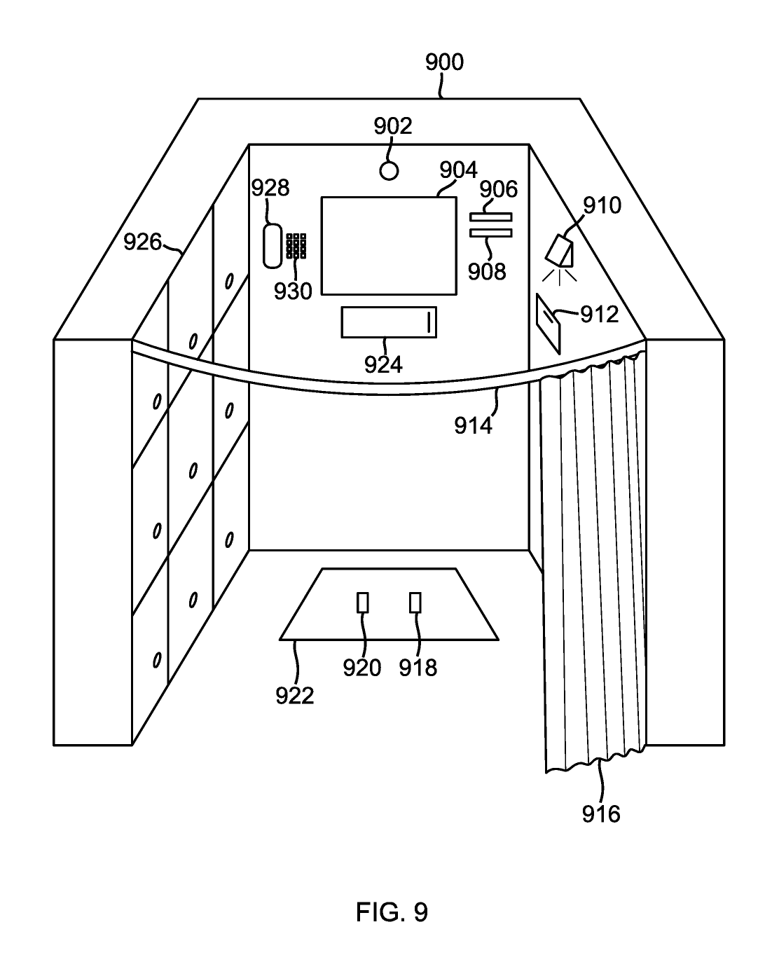

FIG. 9 shows a booth 900 wherein the pharmaceutical dispensing method is used. The booth 900 comprises a camera 902, a user interface 904, card scanners 906 and 908, a scanner 910, a receptacle 912, a privacy barrier 916, a privacy barrier support 914, bioimpedance sensors 918 and 920, a scale 922, a dispensing bay 924, storage compartments 926, a telephone 928, and a user interface 930. The user interface 904 may be used to communicate with medical professionals, view active prescriptions, request prescriptions, or receive instructions on operation of medical diagnostic equipment, along with other functions that may be necessary for execution of the pharmaceutical dispensing method. The card scanners 906 and 908 are both provided so that a user may be required to leave their identification card inserted into the card scanner 906 for the duration of their time in the booth 900 but they may use the card scanner 908 for payment purposes while the card scanner 906 is in use. The user interface 930 is used to operate the telephone 928. Medicine is dispensed in the dispensing bay 924. Excess medicine may be scanned by the scanner 910 and disposed of in the receptacle 912. The privacy barrier 916 may be a curtain or some other divider such that a user may slide the privacy barrier 916 along the privacy barrier support 914. Medical diagnostic equipment is stored in the storage compartments 926.

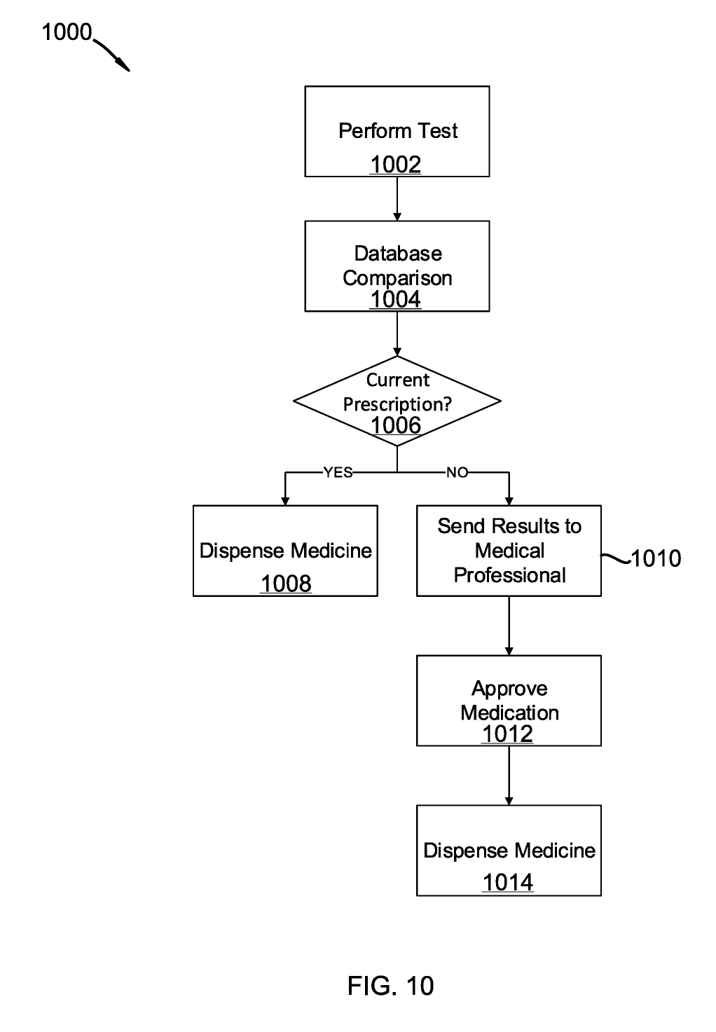

FIG. 10 shows a method of pharmaceutical prescription 1000 wherein a user undergoes diagnostic tests 1002, following which their results are compared with a database 1004 containing medical records of the user. Following the comparison with database 1004 the user's active prescriptions (if any) are presented to the user. The user may choose to refill an active prescription in which case the medicine may be dispensed 1008. If the user needs or is seeking medication that he or she does not have a prescription for, results from the diagnostic tests are sent 1010 to a medical professional for review. The medical professional may give approval 1012 for the requested prescription, following which the prescribed medicine may be dispensed 1014. If the medical professional approves the request immediately then a prescription may be immediately filled. Otherwise, it may be necessary for the user to return at a later time to have their prescription filled.

The systems and methods disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A pharmaceutical dispensing method comprising:
identifying a user by a password, identification card, or biometric verification;
obtaining pharmaceutical or health records of the user based on an identity of the user;
allowing the user access to securely stored medical diagnostic equipment in an unattended medical kiosk based on the identity of the user;
instructing the user on how to use the medical diagnostic equipment to perform diagnostic testing on the user;
obtaining diagnostic testing results from the medical diagnostic equipment being used by the user;
comparing the results of the diagnostic tests with the pharmaceutical or health database records of the user to confirm the identity of the user; and
dispensing medicine to the user from the unattended medical kiosk based on the confirmed user identity and the diagnostic tests of the user.

2. The pharmaceutical dispensing method of claim 1, wherein the medicine and medical diagnostic equipment are stored in the unattended medical kiosk, the unattended medical kiosk comprising a privacy barrier, a scale, and a user interface.

3. The pharmaceutical dispensing method of claim 1, wherein the identification card is a government issued form of identification or a card produced specifically for use with the medical kiosk.

4. The pharmaceutical dispensing method of claim 1, further comprising providing a user payment interface such that the user is required to pay before the medicine is dispensed.

5. The pharmaceutical dispensing method of claim 4, wherein the user payment is used as an additional form of identification.

6. The pharmaceutical dispensing method of claim 4, further comprising providing an exception to the user payment such that user payment is not required prior to dispensing medicine if the diagnostic tests indicate immediate risk of death or serious impairment.

7. The pharmaceutical dispensing method of claim 1, further comprising providing a telephone such that a call is automatically made to local emergency paramedic services if the user is determined to be at immediate risk of death or severe impairment.

8. The pharmaceutical dispensing method of claim 1, wherein results of the diagnostic tests are uploaded to an Internet accessible database and are viewable by qualified medical personnel with permission to view them.

9. The pharmaceutical dispensing method of claim 8, wherein the results are automatically reported to a doctor, and a medium through which a medical report is delivered varies based on severity, as determined by the results of the diagnostic tests.

10. The pharmaceutical dispensing method of claim 1, wherein dispensing medicine is approved if the user has a pre-existing prescription or a medical professional has remotely approved the dispensing of the medicine based on the diagnostic tests.

11. The pharmaceutical dispensing method of claim 1, wherein dispensing medication is approved by a medical professional responding to a text message.

12. The pharmaceutical dispensing method of claim 1, further comprising allowing the user to dispose of excess or old medication in a receptacle in the unattended medical kiosk.

13. The pharmaceutical dispensing method of claim 12, wherein the receptacle has a scanner that is used to scan a pill container and determine the contents of the pill container prior to disposal in the receptacle.

14. The pharmaceutical dispensing method of claim 12, wherein the excess or old medication is received by the receptacle into a sorting mechanism and sorted according to pill dimensions or constituents.

15. The pharmaceutical dispensing method of claim 12, wherein the receptacle further comprises providing an incinerator such that disposed medicine may be subsequently incinerated.

16. The pharmaceutical dispensing method of claim 1, further comprising variable functionality to accommodate for laws or security requirements of different geographic locations.

17. The pharmaceutical dispensing method of claim 2, further comprising tethers such that the medical diagnostic equipment remains attached to the unattended medical kiosk.

18. The pharmaceutical dispensing method of claim 1, wherein the medical diagnostic equipment contains embedded location sensors such that stolen or lost equipment may be remotely located.

19. The pharmaceutical dispensing method of claim 1, further comprising inserting the identification card into a scanner and requiring that the identification card not be removed until the pharmaceutical dispensing method is complete.

20. The pharmaceutical dispensing method of claim 1, wherein the biometric verification is accomplished by any combination of a fingerprint scan, bioimpedance reading, retinal scan, facial scan, height measurement, weight measurement, or a combination thereof.
